(19) United States
(12) Patent Application Publication
(10) Pub. No.: US 2021/0343493 A1
(43) Pub. Date: Nov. 4, 2021

(54) ELECTROMAGNETIC RELAY

(71) Applicant: OMRON Corporation, Kyoto-shi, Kyoto (JP)

(72) Inventors: Shingo MORI, Yamaga-shi, Kumamoto (JP); Ryota MINOWA, Yamaga-shi, Kumamoto (JP); Yasuo HAYASHIDA, Yamaga-shi, Kumamoto (JP); Naoki KAWAGUCHI, Yamaga-shi, Kumamoto (JP); Kohei OTSUKA, Yamaga-shi, Kumamoto (JP); Hiroyuki IWASAKA, Yamaga-shi, Kumamoto (JP)

(21) Appl. No.: 17/283,253

(22) PCT Filed: Sep. 18, 2019
(86) PCT No.: PCT/JP2019/036489

§ 371 Date: Apr. 7, 2021

(30) Foreign Application Priority Data
Oct. 10, 2018 (JP) 2018-192042

(51) Int. Cl. H01H 50/12; H01H 50/02; H01H 50/54; H01H 50/36

(52) U.S. Cl. CPC H01H 50/12; H01H 50/36; H01H 50/54; H01H 50/02

(57) ABSTRACT

An electromagnetic relay includes a fixed terminal, a movable contact piece, a housing, and a heat dissipation structure. The fixed terminal includes a first surface, a second surface opposite the first surface, and a fixed contact disposed on the first surface. The movable contact piece includes a movable contact that is configured to contact the fixed contact. The housing includes an accommodation space accommodating a portion of the fixed terminal, the fixed contact, and the movable contact piece. The heat dissipation structure includes a heat dissipation space that is provided on the second surface of the fixed terminal for dissipating the heat of the fixed terminal to an outside of the accommodation space.

### CROSS-REFERENCE TO RELATED APPLICATION

This application is the U.S. National Phase of International Application No. PCT/JP2019/036489, filed on Sep. 18, 2019. This application claims priority to Japanese Patent Application No. 2018-192042, filed Oct. 10, 2018. The contents of those applications are incorporated by reference herein in their entireties.

### FIELD

The present invention relates to an electromagnetic relay.

### BACKGROUND

Conventionally, relays are known that open and close an electric circuit. The electromagnetic relay described in Japanese Patent No. 6300153 has a fixed terminal including a fixed contact, a movable contact piece including a movable contact, a drive shaft, and an electromagnetic drive device including a coil. The movable contact piece is connected to the drive shaft to be integrally movable with it. Driving of the electromagnetic drive device causes the movable contact piece to move with the drive shaft, and the fixed contact contacts or separates from the movable contact, resulting in closing or opening the electric circuit.

While the fixed contact is in contact with the movable contact, i.e., during energization, the components including the fixed terminal, the movable contact piece, and the coil of the electromagnetic drive device generate heat. In order to efficiently release the heat generated by the coil of the electromagnetic drive device to the case during energization, Japanese Patent No. 6300153 discloses a configuration in which an intervening member having a higher thermal conductivity than air is placed in the gap between the electromagnetic drive device and the case in which the electromagnetic drive device is housed.

In Japanese Patent No. 6300153, even if the heat generated in the coil of the electromagnetic drive device during energization can be efficiently dissipated to the case, it is difficult to efficiently release the heat generated in the fixed terminal and movable contact piece during energization.

The issue the present invention addresses is to provide an electromagnetic relay capable of efficiently releasing the heat generated in the fixed terminal and movable contact piece during energization.

### SUMMARY

(1) An electromagnetic relay according to one aspect of the present invention includes a first fixed terminal, a movable contact piece, a housing, and a heat dissipation structure. The fixed terminal includes a first surface, a second surface opposite to the first surface, and a fixed contact disposed on the first surface. The movable contact piece includes a movable contact configured to contact the fixed contact. The housing includes an accommodation space accommodating a portion of the fixed terminal, the fixed contact, and the movable contact piece. The heat dissipation structure includes a heat dissipation space provided on the second surface side of the fixed terminal for dissipating the heat of the fixed terminal to an outside of the accommodation space.

In this electromagnetic relay, since the heat dissipation space for dissipating the heat of the fixed terminal is provided on the second surface side of the fixed terminal, the heat generated in the fixed terminal during energization can be efficiently dissipated from the second surface side of the fixed terminal to the outside of the accommodation space. In addition, the heat of the movable contact piece can be efficiently dissipated outside the accommodation space through the fixed terminal.

(2) Preferably, the heat dissipation structure further includes a heat conduction member that is disposed in the heat dissipation space and that has a higher thermal conductivity than air. In this case, the heat conduction member enables the heat generated in the fixed terminal, during energization, to be dissipated more efficiently from the second surface side of the fixed terminal to the outside of the accommodation space.

(3) Preferably, the heat conduction member is disposed in contact with at least one of the housing and the fixed terminal. In this case, since the heat conduction member is arranged in contact with at least one of the housing and the fixed terminal, the heat generated in the fixed terminal, during energization, can be further efficiently dissipated outside the accommodation space.

(4) Preferably, the heat dissipation structure further includes a vent connecting the heat dissipation space to the outside of the housing. In this case, the heat generated in the fixed terminal, during energization, can be more efficiently dissipated from the heat dissipation space to the outside of the accommodation space.

(5) Preferably, the electromagnetic relay further includes a contact case, the case defining the accommodation space and the heat dissipation space and supporting the fixed terminal, and the heat dissipation space is disposed adjacent to the accommodation space. In this case, the heat generated in the fixed terminal can be efficiently dissipated to the heat dissipation space through the contact case.

(6) Preferably, the electromagnetic relay further includes a drive shaft and an electromagnetic drive device. The drive shaft is movable with the movable contact piece in a first direction in which the movable contact contacts the fixed contact, and in a second direction in which the movable contact separates from the fixed contact. The electromagnetic drive device moves the drive shaft in the first and second directions. The contact case includes a bottom and a contact support portion that is disposed on the second direction side of the bottom for supporting the fixed terminal. The fixed terminal has its second surface that is supported by the contact support portion of the contact case. The heat dissipation space is disposed on the first direction side of the contact support portion. In this case, the contact support portion allows the space on the first direction side of the contact support portion to be effectively used as a heat dissipation space.

(7) Preferably, the electromagnetic drive device includes a yoke disposed on the first direction side of the heat dissipation space, and the heat dissipation space is surrounded by the contact support portion of the contact case and the yoke. In this case, the heat generated in the fixed terminal, during energization, can be dissipated to the yoke.

(8) Preferably, the electromagnetic relay further includes a contact case, a drive shaft, and an electromagnetic drive device. The contact case defines the accommodation space and the heat dissipation space. The drive shaft is movable with the movable contact piece in a first direction in which the movable contact contacts the fixed contact, and in a second direction in which the movable contact separates from the fixed contact. The electromagnetic drive device includes a yoke that is disposed on the first direction side of the heat dissipation space and that moves the drive shaft in the first and second directions. The contact case includes a bottom and a contact support portion disposed on the second direction side of the bottom for supporting the fixed terminal. The fixed terminal is, at the second surface, supported by the contact support portion of the contact case. The heat dissipation space is disposed on the first direction side of the contact support portion and adjacent to the accommodation space. The heat conduction member is disposed in contact with at least one of the contact case and the yoke. In this case, since the heat conduction member is disposed in contact with at least one of the contact case and the yoke, the heat of the fixed terminal, during energization, can be further efficiently dissipated outside the accommodation space.

(9) Preferably, the heat dissipation structure further includes a vent connecting the heat dissipation space to the outside of the housing. In this case, in addition to the above effects, the heat generated in the fixed terminal, during energization, can be more efficiently dissipated from the heat dissipation space to the outside of the accommodation space.

### BRIEF DESCRIPTION OF THE DRAWINGS

FIG. 1 is a cross-sectional view of an electromagnetic relay according to an embodiment of the present invention.

FIG. 2 is a plan view of a contact case.

FIG. 3 is an enlarged cross-sectional view illustrating the periphery of the contact case.

FIG. 4 is a cross-sectional view of an electromagnetic relay when a voltage is applied to the coil.

FIG. 5 is an enlarged cross-sectional view illustrating the periphery of a contact case according to a first modification.

FIG. 6 is an enlarged cross-sectional view illustrating the periphery of a contact case according to a second modification.

FIG. 7 is a schematic side view of an electromagnetic relay according to a fourth modification.

FIG. 8 is a schematic side view of an electromagnetic relay according to a fourth modification.

### DETAILED DESCRIPTION

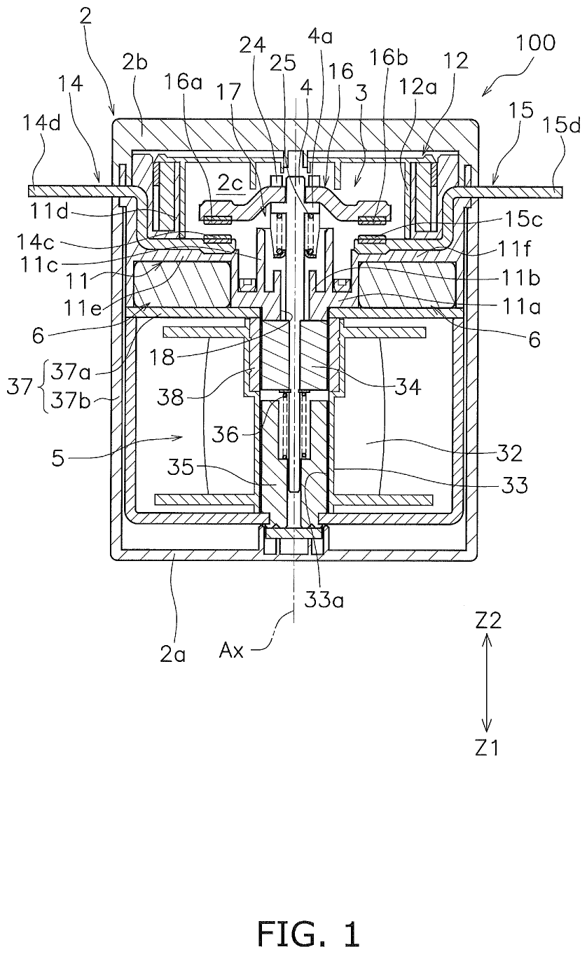

The following is an embodiment of an electromagnetic relay according to one aspect of the present invention, which will be described with reference to the drawings. FIG. 1 is a cross-sectional view of an electromagnetic relay 100. As shown in FIG. 1, the electromagnetic relay 100 includes a housing 2, a contact device 3, a drive shaft 4, an electromagnetic drive device 5, and a heat dissipation structure 6. In the following description, the direction in which the axis line Ax of the drive shaft 4 extends is referred to as the “axial direction.” When referring to the drawings, the upper side in FIG. 1 is referred to as “up”, the lower side as “down”, the left side as “left”, and the right side as “right” for the sake of clarity. In this embodiment, the downward direction in FIG. 1 corresponds to the contact direction Z1. The upward direction in FIG. 1 corresponds to the separating direction Z2 in FIG. 1. The details of the contact direction Z1 and the separating direction Z2 will be described later.

The housing 2 includes a case 2a and a cover 2b. The case 2a is an approximately rectangular box and is open at the top. The cover 2b covers the upper part of the case 2a. The housing 2 is sealed inside by the case 2a and cover 2b. The case 2a and cover 2b are comprised of insulating material. The contact device 3, the drive shaft 4, and the electromagnetic drive device 5 are housed inside the housing 2.

The housing 2 includes an accommodation space 2c for accommodating the contact device 3. The accommodation space 2c is enclosed, in this embodiment, by a contact case 11 and a contact cover 12 both disposed in the housing 2. The contact case 11 and the contact cover 12 are comprised of insulating material.

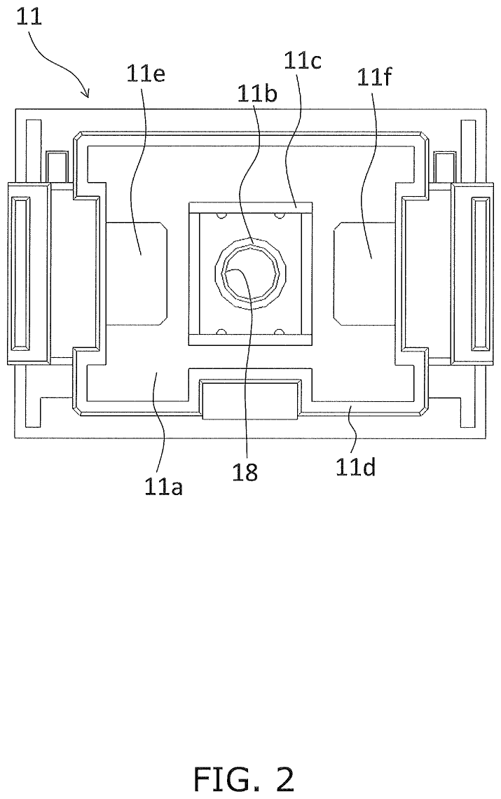

FIG. 2 is a plan view of the contact case 11. As shown in FIGS. 1 and 2, the contact case 11 includes a bottom 11a, a cylindrical part 11b, an inner wall 11c, and an outer wall 11d. The bottom 11a is rectangular and plate-shaped. The bottom 11a has a longitudinal direction that corresponds to the left-right direction in FIG. 1.

The cylindrical part 11b extends in the axial direction in a cylindrical shape. The cylindrical part 11b protrudes downward from the center of the bottom 11a and upward from the center of the bottom 11a. The cylindrical part 11b has a through hole 18 penetrating the bottom 11a in the axial direction. The through hole 18 axially penetrates the center of the bottom 11a. The drive shaft 4 passes through the through hole 18 axially.

The inner wall 11c is rectangular in a plan view and extends upward in a plate form from the bottom 11a to surround the outer circumference of the cylindrical part 11b. The inner wall 11c extends upward beyond the cylindrical part 11b. The space enclosed by the inner wall 11c accommodates a part of a contact piece holding unit 17 which will be described later.

The outer wall 11d is located at a position from the cylindrical part 11b farther than the inner wall 11c. The outer wall 11d extends upward in a plate form from the bottom 11a. The outer wall 11d has an approximately rectangular shape in a plan view and extends upward beyond the inner wall 11c.

The contact case 11 further includes a first contact support portion 11e and a second contact support portion 11f. The first contact support portion 11e is disposed to the left of the center of the bottom 11a in the longitudinal direction. The first contact support portion 11e has a rectangular shape and protrudes upward from the bottom 11a. The first contact support portion 11e is configured to penetrate a portion of the outer wall 11d in the left-right direction. The first contact support portion 11e is disposed opposite the inner wall 11c in the left-right direction. The second contact support portion 11f is symmetrical in shape to the first contact support portion 11e, and is therefore omitted from the description.

The contact cover 12 covers the upper part of the contact case 11. The contact cover 12 includes an arc extending wall 12a extending toward the bottom 11a along the outer wall 11d of the contact case 11.

The contact device 3 includes a first fixed terminal 14, a second fixed terminal 15, a movable contact piece 16, and the contact piece holding unit 17. The first fixed terminal 14, the second fixed terminal 15, and the movable contact piece 16 are comprised of conductive material.

The first fixed terminal 14 is formed by bending a plate-shaped member. The first fixed terminal 14 has: one end that is housed in the accommodation space 2c; and the other end protruding from the housing 2 in the left-right direction and exposed to the outside of the housing 2. The first fixed terminal 14 is disposed at the upper part of the first contact support portion 11e of the contact case 11. The first fixed terminal 14 is supported at its second surface 14b, to be described later, in contact with the first contact support portion 11e of the contact case 11.

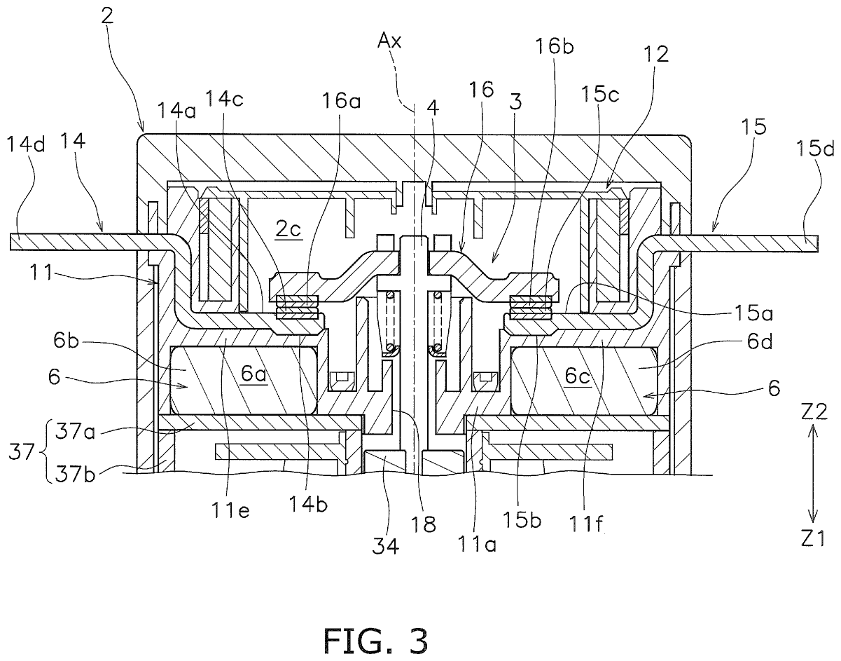

FIG. 3 is an enlarged cross-sectional view illustrating the periphery of the contact case 11. As shown in FIG. 3, the first fixed terminal 14 includes a first surface 14a, a second surface 14b, a first fixed contact 14c, and a first external connection 14d. The first surface 14a corresponds to the surface on the separating direction Z2 side. The second surface 14b is opposite the first surface 14a and corresponds to the surface on the contact direction Z1 side. The second surface 14b is in contact with the first contact support portion 11e of the contact case 11. The contact is not necessarily direct contact, and may be indirect contact. The first fixed contact 14c is disposed on the first surface 14a in the accommodation space 2c.

The second fixed terminal 15 is supported by the second contact support portion 11f of the contact case 11 in the housing 2. The second fixed terminal 15 includes a first surface 15a, a second surface 15b, a second fixed contact 15c, and a second external connection 15d. The second fixed terminal 15 is symmetrical in shape to the first fixed terminal 14, and is therefore omitted from the description.

The movable contact piece 16 is disposed opposite the first fixed contact 14c and the second fixed contact 15c in the accommodation space 2c. The movable contact piece 16 is disposed above the first fixed contact 14c and the second fixed contact 15c. The movable contact piece 16 includes a first movable contact 16a and a second movable contact 16b. The first movable contact 16a is disposed opposite the first fixed contact 14c and is contactable with the first fixed contact 14c. The second movable contact 16b is disposed opposite the second fixed contact 15c and is contactable with the second fixed contact 15c. Note that FIG. 3 illustrates a state where the first movable contact 16a and the second movable contact 16b are in contact with the first fixed contact 14c and the second fixed contact 15c, respectively.

The movable contact piece 16 is movable in the contact direction Z1 in which it contacts the first fixed contact 14c and the second fixed contact 15c, and in the separating direction Z2 in which it separates from the first fixed contact 14c and the second fixed contact 15c. The contact direction Z1 is an example of the first direction, and the separating direction Z2 is an example of the second direction.

The contact direction Z1 is the direction in which the first movable contact 16a and the second movable contact 16b contact the first fixed contact 14c and the second fixed contact 15c (downward in FIG. 1). The separating direction Z2 is the direction in which the first movable contact 16a and the second movable contact 16b separate from the first fixed contact 14c and the second fixed contact 15c (upward in FIG. 1). The contact direction Z1 and the separating direction Z2 coincide with the axial direction.

The contact piece holding unit 17 holds the movable contact piece 16 via the drive shaft 4, as shown in FIG. 1. The contact piece holding unit 17 connects the movable contact piece 16 to the drive shaft 4. The contact piece holding unit 17 includes a holder 24 and a contact spring 25. The movable contact piece 16 is held in the axial direction between the upper part of the holder 24 and the flange 4a of the drive shaft 4. The contact spring 25 is disposed between the bottom of the holder 24 and the flange 4a of the drive shaft 4, and pushes the drive shaft 4 and the movable contact piece 16 toward the separating direction Z2 side.

The drive shaft 4 extends along the contact direction Z1 and the separating direction Z2. The drive shaft 4 is connected to the movable contact piece 16 via the contact piece holding unit 17. The drive shaft 4 is movable with the movable contact piece 16 in the contact direction Z1 and the separating direction Z2.

The electromagnetic drive device 5 moves the drive shaft 4 in the contact direction Z1 and the separating direction Z2 by electromagnetic force. The electromagnetic drive device 5 is disposed in a space different from the accommodation space 2c in the housing 2. In this embodiment, the electromagnetic drive device 5 is disposed below the contact case 11.

The electromagnetic drive device 5 includes a coil 32, a spool 33, a movable iron core 34, a fixed iron core 35, a biasing member 36, and a yoke 37.

The coil 32 is mounted on the outer circumference of the spool 33. The spool 33 includes an accommodating part 33a. The accommodating part 33a is located inside the spool 33. The accommodating part 33a is cylindrical and axially extends. In the axial direction, the accommodating part 33a overlaps the through hole 18 in the cylindrical part 11b of the contact case 11. The drive shaft 4 is partially disposed in the accommodating part 33a.

A movable iron core 34 is disposed within the accommodating part 33a. The movable iron core 34 is cylindrical in shape and is connected to the drive shaft 4, with the drive shaft 4 penetrating through the center in the axial direction, so that the movable iron core 34 is movable integrally with the drive shaft 4. The movable iron core 34 is movable in the axial direction together with the drive shaft 4. In this embodiment, the movable iron core 34 is guided in the axial direction by an annular iron core 38 disposed in the accommodating part 33a.

The fixed iron core 35 is disposed opposite the movable iron core 34 on the contact direction Z1 side of the movable iron core 34 in the accommodating part 33a. The fixed iron core 35 is fixed to the yoke 37.

The biasing member 36 is, for example, a coil spring and is disposed between the movable iron core 34 and the fixed iron core 35. The biasing member 36 urges the movable iron core 34 toward the separating direction Z2. Therefore, the biasing member 36 is placed between the movable iron core 34 and the fixed iron core 35 in a compressed state.

The yoke 37 includes a first yoke 37a and a second yoke 37b. The first yoke 37a is plate-shaped and is disposed between the bottom 11a of the contact case 11 and the spool 33. The first yoke 37a is fixed to the bottom 11a of the contact case 11 by a plurality of screw members not shown. The first yoke 37a overlaps the first contact support portion 11e and the second contact support portion 11f of the contact case 11 in the axial direction. The first yoke 37a overlaps with the lower portion of the cylindrical part 11b in the left-right direction. The first yoke 37a is connected to the annular iron core 38. The second yoke 37b has an approximately U-shape with the bottom located below the spool 33 and connected to the fixed iron core 35. The second yoke 37b is connected to the first yoke 37a, at the upper ends of the two side portions thereof.

The heat dissipation structure 6 includes a first heat dissipation space 6a and a first heat conduction member 6b, as shown in FIG. 3. The first heat dissipation space 6a is a space for releasing heat of the first fixed terminal 14 outside the accommodation space 2c, and is disposed on the second surface 14b side of the first fixed terminal 14. In more detail, the first heat dissipation space 6a is disposed on the contact direction Z1 side of the first contact support portion 11e of the contact case 11. The first heat dissipation space 6a is disposed at a position adjacent to the accommodation space 2c and is defined separate from the accommodation space 2c. In this embodiment, the accommodation space 2c and the first heat dissipation space 6a are defined by the contact case 11. The first heat dissipation space 6a is, for example, an approximately rectangular space that is formed on the contact direction Z1 side of the first contact support portion 11e when the contact case 11 is resin molded. The contact direction Z1 side of the first heat dissipation space 6a is covered by the first yoke 37a. Therefore, the first heat dissipation space 6a is surrounded by the first contact support portion 11e and the first yoke 37a in this embodiment.

The first heat conduction member 6b is a member having a higher thermal conductivity than air. The first heat conduction member 6b in this embodiment is preferably a non-metal and is comprised of a material such as, for example, urethane, silicon, or epoxy resin. The first heat conduction member 6b is disposed in at least a part of the first heat dissipation space 6a. The first heat conduction member 6b has a rectangular shape in this embodiment, and is disposed so as to fill the first heat dissipation space 6a. The first heat conduction member 6b is disposed in contact with at least one of the first contact support portion 11e and the first yoke 37a. In this embodiment, the first heat conduction member 6b is disposed in contact with both the first contact support portion 11e and the first yoke 37a. The first heat conduction member 6b may be composed of a metal. In this case, it is preferable to arrange an insulating member between the first heat conduction member 6b and the first yoke 37a so that the first heat conduction member 6b and the first yoke 37a do not come into direct contact.

The heat dissipation structure 6 further includes a second heat dissipation space 6c and a second heat conduction member 6d. The second heat dissipation space 6c is a space for releasing heat of the second fixed terminal 15 outside the accommodation space 2c, and is provided on the second surface 15b side of the second fixed terminal 15. The second heat conduction member 6d is disposed in at least a part of the second heat dissipation space 6c. Since the second heat dissipation space 6c and the second heat conduction member 6d are symmetrical in shape to the first heat dissipation space 6a and the first heat conduction member 6b, the description is omitted.

Next, the operation of the electromagnetic relay 100 will be described. FIG. 1 shows a state where no voltage is applied to the coil 32. While no voltage is applied to the coil 32, the biasing member 36 causes the movable iron core 34 not to move in the contact direction Z1. Thus, the first movable contact 16a and the second movable contact 16b are separated from the first fixed contact 14c and the second fixed contact 15c.

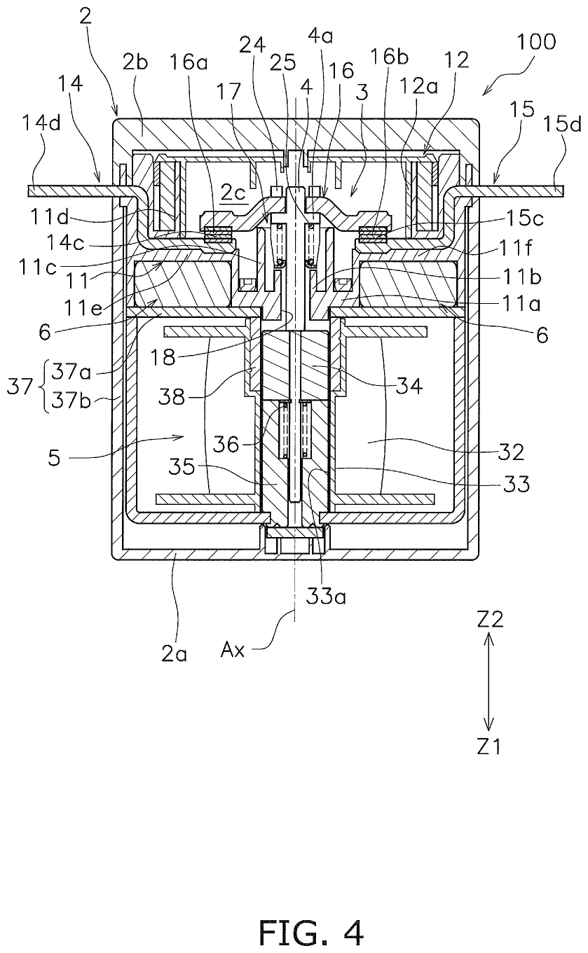

FIGS. 3 and 4 show a state where a voltage is applied to the coil 32. When a voltage is applied to the coil 32 to energize it, the electromagnetic force of the coil 32 causes the movable iron core 34 to move in the contact direction Z1 against the elastic force of the biasing member 36. With the movement of the movable iron core 34, the drive shaft 4 and the movable contact piece 16 move in the contact direction Z1, and the first movable contact 16a and the second movable contact 16b contact the first fixed contact 14c and the second fixed contact 15c.

When the application of the voltage to the coil 32 is stopped, the movable iron core 34 moves in the separating direction Z2 by the elastic force of the biasing member 36, and the first movable contact 16a and the second movable contact 16b enters a state where they are separate from the first fixed contact 14c and the second fixed contact 15c.

In the electromagnetic relay 100 of this embodiment, while the first movable contact 16a and the second movable contact 16b are in contact with the first fixed contact 14c and the second fixed contact 15c, i.e., during energization, the heat of the first fixed terminal 14, the second fixed terminal 15, and the movable contact piece 16 is efficiently dissipated outside the accommodation space 2c by the heat dissipation structure 6. Specifically, the heat of the first fixed terminal 14 can be efficiently dissipated outside the accommodation space 2c by the first heat dissipation space 6a and the first heat conduction member 6b. Further, since the first heat conduction member 6b is arranged in contact with the first contact support portion 11e and the first yoke 37a, the heat of the first fixed terminal 14 during energization can be efficiently dissipated to the first yoke 37a. Furthermore, the heat of the movable contact piece 16 during energization can be efficiently dissipated outside the accommodation space 2c via the first fixed terminal 14. Note that the heat of the second fixed terminal 15 during energization can be dissipated outside the accommodation space 2c by the second heat dissipation space 6c and the second heat conduction member 6d.

An embodiment of the electromagnetic relay according to one aspect of the present invention has been described above. The present invention, however, is not limited to the above embodiment, and various changes can be made without departing from the gist of the present invention. For example, the configuration of the electromagnetic drive device 5 may be changed. The shapes or arrangements of the housing 2, contact case 11, contact cover 12, and yoke 37 may be changed.

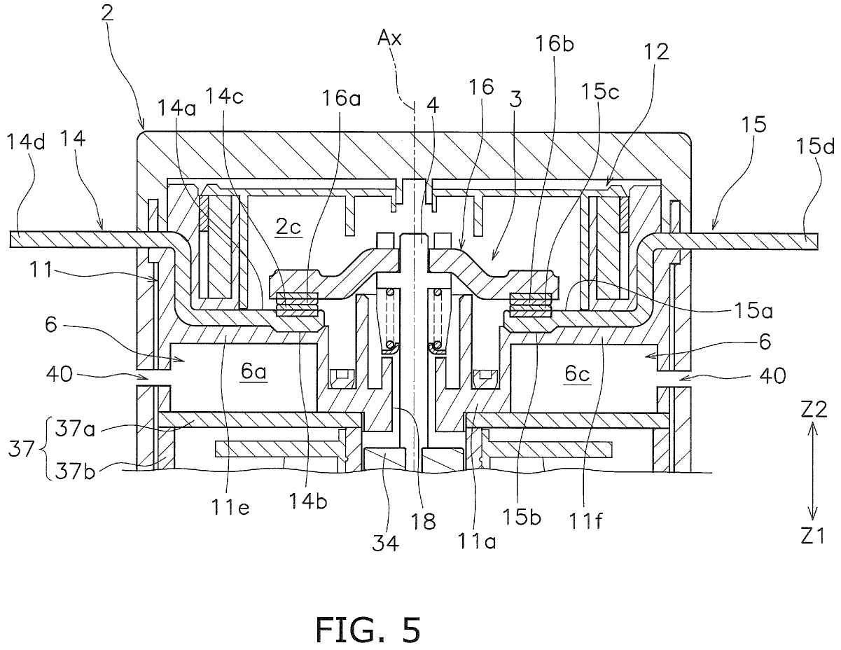

FIG. 5 is an enlarged cross-sectional view illustrating the periphery of the contact case 11 according to a first modification. The heat dissipation structure 6 of the first modification further includes the vent 40 connecting the first heat dissipation space 6a to the outside of the housing 2. The heat dissipation structure 6 of the first modification does not include the first heat conduction member 6b and the second heat conduction member 6d. The other configurations are the same as in the above embodiment.

The vent 40 has a configuration to penetrate the contact case 11 and the case 2a of the housing 2 in the left-right direction. In this embodiment, the vent 40 is located at a position overlapping with the first heat dissipation space 6a in the left-right direction. With the vent 40, the heat of the first fixed terminal 14 can be efficiently dissipated through the first heat dissipation space 6a to the outside of the accommodation space 2c. The vent 40 also resides on the second fixed terminal 15 side, so that the vent 40 connects the second heat dissipation space 6c to the outside of the housing 2.

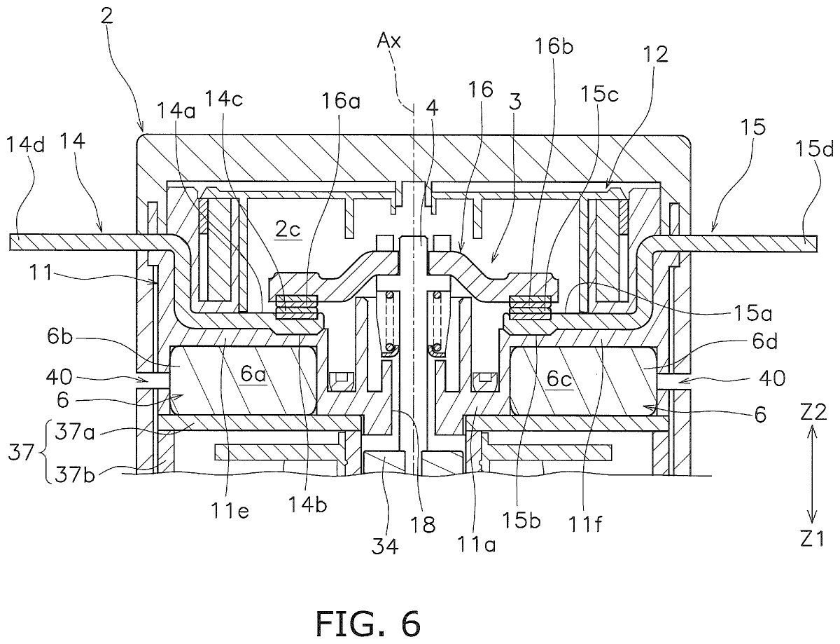

FIG. 6 is an enlarged cross-sectional view illustrating the periphery of the contact case 11 according to a second modification. The heat dissipation structure 6 according to the second modification includes the first heat dissipation space 6a, the first heat conduction member 6b, and the vent 40. In this case, the first heat conduction member 6b and the vent 40 enable the heat of the first fixed terminal 14 to be released more efficiently outside the accommodation space 2c. The positions and shapes of the heat conduction members 6b, 6d and the vent 40 can be changed as needed.

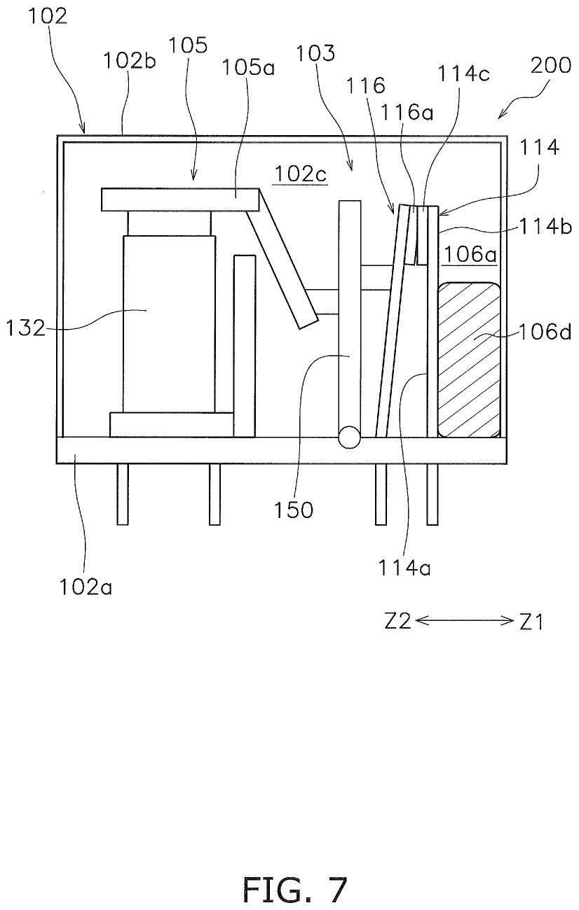

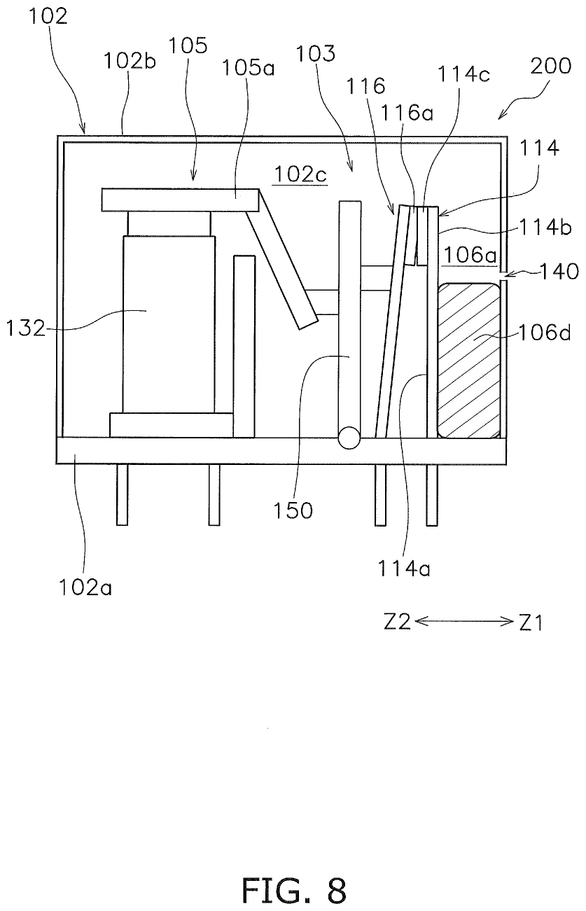

FIG. 7 is a schematic side view of an electromagnetic relay according to a fourth modification. The electromagnetic relay 200 according to the fourth modification is a general hinge-type electromagnetic relay. The electromagnetic relay 200 includes a housing 102, a contact device 103, an electromagnetic drive device 105, and a heat dissipation structure 106. FIG. 8 shows a state where a voltage is applied to the coil 132 of the electromagnetic drive device 105. The operation of the electromagnetic relay 200 will be omitted since it has the same structure as conventional ones.

The housing 102 includes a base 102a, a case 102b, and an accommodation space 102c. In the fourth modification, the accommodation space 102c is surrounded by the base 102a and the case 102b.

The contact device 103 is accommodated in the accommodation space 102c. The contact device 103 includes a fixed terminal 114 and a movable contact piece 116. The fixed terminal 114 is supported by the base 102a. The fixed terminal 114 includes a fixed contact 114c disposed on the first surface 114a. A movable contact piece 116 is disposed opposite the fixed terminal 114 and is supported by the base 102a. The movable contact piece 116 is composed of a conductive and elastically deformable plate spring. The movable contact piece 116 includes a movable contact 116a that is configured to contact the fixed contact 114c.

The electromagnetic drive device 105 includes a movable iron piece 105a that is approximately L-shaped. The movable iron piece 105a is capable of pressing a card 150 in the contact direction Z1, the card 150 being rotatably supported at the bottom of the housing 102.

The heat dissipation structure 106 includes a heat dissipation space 106a and a heat conduction member 106b. The heat dissipation space 106a is provided on the second surface 114b side opposite the first surface 114a of the fixed terminal 114, and dissipates the heat of the fixed terminal 114 outside the accommodation space 102c. The heat dissipation space 106a is surrounded by the case 102b on the contact direction Z1 side. At least a part of the heat dissipation space 106a on the separating direction Z2 side is surrounded by the second surface 114b of the fixed terminal 114.

The heat conduction member 106b is a member that has a higher thermal conductivity than air. The heat conduction member 106b is preferably a non-metal and is comprised of a material such as, for example, urethane, silicon, or epoxy resin. The heat conduction member 106b is disposed in at least a part of the heat dissipation space 106a. The heat conduction member 106b is disposed so as to contact at least one of the housing 102 and the fixed terminal 114. In the present embodiment, the heat conduction member 106b is disposed in contact with both the housing 102 and the fixed terminal 114. The heat conduction member 106b may be composed of a metal. When the heat conduction member 106b is composed of a metal, preferably a gap is formed between the heat conduction member 106b and the fixed terminal 114, or an insulating member is placed between the heat conduction member 106b and the fixed terminal 114.

As shown in FIG. 8, the heat dissipation structure 106 may further include a vent 140. The vent 140 connects the heat dissipation space 106a to the outside of the housing 102. In this embodiment, the vent 140 passes through the case 102b of the housing 102. The vent 140 is preferably located at a position overlapping with the fixed terminal 114 in the separating direction Z2. In the case where the heat dissipation structure 106 includes the vent 140, the heat dissipation structure 106 need not necessarily include the heat conduction member 106b. The positions and shapes of the heat conduction member 106b and the vent 140 can be changed as needed. For example, the vent 140 may be located at a position where it overlaps the fixed terminal 114 in the separating direction Z2.

### INDUSTRIAL APPLICABILITY

The present invention can provide an electromagnetic relay that is able to efficiently dissipate the heat of the fixed terminal and movable contact piece during energization.

### REFERENCE NUMERALS

### 2 Housing

2c Accommodation space
4 Drive shaft
5 Electromagnetic drive device
6 Heat dissipation structure
6a First heat dissipation space (An example of heat dissipation space)
6b First heat conduction member (An example of heat conduction member)
6c Second heat dissipation space (An example of heat dissipation space)
6d Second heat conduction member (An example of heat conduction member)
11 Contact case

### 11a Bottom

11e First contact support (An example of a contact support part)
11f Second contact support (An example of contact support)
14 First fixed terminal (An example of fixed terminal)
14a First surface
14b Second surface
14c First fixed contact (An example of fixed contact)
15 Second fixed terminal (An example of fixed terminal)
15a First surface
15b Second surface
15c Second fixed contact (An example of fixed contact)
16 Movable contact piece
16a First movable contact (An example of movable contact)
16b Second movable contact (An example of movable contact)
37a First yoke (An example of yoke)

### 40 Vent

100 Electromagnetic relay

### 102 Housing

102c Accommodation space
105 Electromagnetic drive device
106 Heat dissipation structure
106a Heat dissipation space
106b Heat conduction member
114 Fixed terminal
114a First surface
114b Second surface
114c Fixed contact
116 Movable contact piece
116a Movable contact
200 Electromagnetic relay
Z1 Contact direction (An example of First direction)
Z2 Separating direction (An example of Second direction)

1. An electromagnetic relay comprising:
a fixed terminal having a first surface and a second surface opposite to the first surface, the fixed terminal including a fixed contact disposed on the first surface;
a movable contact piece including a movable contact configured to contact the fixed contact;
a housing including an accommodation space configured to accommodate a portion of the fixed terminal, the fixed contact, and the movable contact piece; and
a heat dissipation structure including a heat dissipation space provided on a second surface side of the fixed terminal, the heat dissipation space configured to dissipate heat of the fixed terminal to an outside of the accommodation space.

2. The electromagnetic relay according to claim 1, wherein
the heat dissipation structure further includes a heat conduction member disposed in the heat dissipation space, the heat conduction member having a higher thermal conductivity than air.

3. The electromagnetic relay according to claim 2, wherein
the heat conduction member is disposed in contact with at least one of the housing or the fixed terminal.

4. The electromagnetic relay according to claim 1, wherein
the heat dissipation structure further includes a vent configured to connect the heat dissipation space to an outside of the housing.

5. The electromagnetic relay according to claim 1, further comprising:
a contact case configured to define the accommodation space and the heat dissipation space, the contact case further configured to support the fixed terminal, wherein
the heat dissipation space is disposed adjacent to the accommodation space.

6. The electromagnetic relay according to claim 5, further comprising:
a drive shaft movable with the movable contact piece in a first direction in which the movable contact contacts the fixed contact, and in a second direction in which the movable contact separates from the fixed contact; and
an electromagnetic drive device configured to move the drive shaft in the first direction and the second direction, wherein
the contact case has a bottom, the contact case including a contact support portion disposed on a second direction side with respect to the bottom, the contact support portion configured to support the fixed terminal,
the fixed terminal is, at the second surface, supported by the contact support portion of the contact case, and
the heat dissipation space is disposed on a first direction side with respect to the contact support portion.

7. The electromagnetic relay according to claim 6, wherein
the electromagnetic drive device includes a yoke disposed on the first direction side with respect to the heat dissipation space, and
the heat dissipation space is surrounded by the contact support portion of the contact case and the yoke.

8. The electromagnetic relay according to claim 2, further comprising:
a contact case configured to define the accommodation space and the heat dissipation space;
a drive shaft movable with the movable contact piece in a first direction in which the movable contact contacts the fixed contact and in a second direction in which the movable contact separates from the fixed contact;
an electromagnetic drive device including a yoke disposed on a first direction side with respect to the heat dissipation space, the electromagnetic drive device configured to move the drive shaft in the first direction and the second direction, wherein
the contact case has a bottom, the contact case including a contact support portion disposed on a second direction side with respect to the bottom, the contact support portion configured to support the fixed terminal,
the fixed terminal is, at the second surface, supported by the contact support portion of the contact case,
the heat dissipation space is disposed on the first direction side with respect to the contact support portion and adjacent to the accommodation space, and
the heat conduction member is disposed in contact with at least one of the contact case or the yoke.

9. The electromagnetic relay according to claim 8, wherein
the heat dissipation structure further includes a vent configured to connect the heat dissipation space to an outside of the housing.
